(19) United States
(12) Patent Application Publication
(10) Pub. No.: US 2026/0339301 A1
(43) Pub. Date: Oct. 29, 2026

(54) METHOD FOR OPERATING A CONNECTION MODULE

(71) Applicant: Murrelektronik GmbH, Oppenweiler (DE)

(72) Inventors: Sebastian Pfestorf, Backnang (DE); Paul Zeller, Flein (DE); Ulrich Kohl, Aspach (DE)

(21) Appl. No.: 19/110,880

(22) PCT Filed: Sep. 28, 2023
(86) PCT No.: PCT/EP2023/076841

§ 371 Date: Mar. 12, 2025

(30) Foreign Application Priority Data
Sep. 30, 2022 (EP) 22199162.3
Nov. 10, 2022 (EP) 22206798.5

(51) Int. Cl. G05B 19/418

(52) U.S. Cl. CPC G05B 19/4184

(57) ABSTRACT

The invention relates to a method (100) for operating a connection module (4) in a computer-aided installation of a machine (1), in particular a plant (1), wherein the connection module (4) is designed for a decentralized and modular connection of components of the machine (1), wherein the method (100) comprises the following steps:
Providing an installation function of the connection module (4) for the installation of the machine (1), wherein the installation function initiates an output of an installation information for supporting an establishment of the connection of the components;
Providing an operational function of the connection module (4) for an operation of the installed machine (1), the operational function initiating an electrical output to the connected components; and
Initiating an installation mode on the connection module (4), wherein the operational function is deactivated and the installation function is activated.

### TECHNICAL AREA

The present invention relates generally to the field of planning and assembly of machines such as automation systems, and in particular to an operation of a connection module in a computer-aided installation of such a machine.

### BACKGROUND

The complexity and variety of automation systems that need to be developed, planned, installed, maintained and repaired is constantly increasing. In all phases of the life cycle of such a plant, such as development/planning, production, commissioning, operation and maintenance, efficient and effective support for an installer or planner through comprehensive and, above all, complete documentation is becoming increasingly important. However, the documentation available in practice, for example in the form of circuit diagrams, does not always meet this requirement, as poorly coordinated work processes or the use of poorly coordinated documentation tools mean that installation activities are not entered sufficiently or completely. These known circumstances inevitably lead to documentation gaps in the plant documentation, which makes reliable maintenance or repair of a plant more difficult or, in the worst case, impossible.

It is a task of the present invention to at least reduce disadvantages of the prior art with regard to the installation of machines. In particular, it is a task underlying the invention to provide a computer-aided method and a system to enable a simpler, faster, safer and error-free installation of electrical components while at least partially overcoming the above-mentioned disadvantages of the prior art.

### DESCRIPTION OF THE INVENTION

The above task is solved by a method, a connection module, a computer program and an apparatus for data processing according to the independent patent claims. Further features and details of the invention may be seen from the respective sub-claims, the description and the drawings.

The object of the invention is in particular a method, preferably computer-implemented, for operating a connection module in a computer-aided installation of a machine, in particular a plant. The connection module may be designed for a decentralized and modular connection of components of the machine. For the installation of the machine, it may be provided that several connection modules are arranged in a spatially decentralized manner. Thus, the method may also be provided for the computer-aided, in particular electrical, installation of several spatially decentralized connection modules and/or the components of the machine to be connected thereto.

The machine may be designed as at least one of the following machines:
An automation system,
A production plant,
A logistics facility,
A production line,
A machining center,
An industrial robot,
A manufacturing facility,
An aggregate,
An electrical appliance.

In particular, the machine may be designed as a machine with a modular character or as a mobile or movable machine, in which individual parts of the machine are installed modularly in accordance with an installation specification. This installation is at least partially carried out manually by a user such as a worker.

The connection module may be an electrical connection module, which makes it possible to connect the components of the machine in a decentralized manner. Furthermore, the connection module may be connected to a control device such as a PLC so that the control device may control the components connected to the connection module in operational mode and thus enable operation of the machine. The control device may also be connected to several other, decentralized connection modules in order to control the respective connected components of the machine. In this way, a decentralized connection of the components may be provided via the connection modules with the control device.

Furthermore, a connection module may preferably have several connection points, wherein a component may be connected to each of the connection points and thus connected to the connection module. For example, a connection module may have at least two or at least four or at least eight or at least 10 connection points. A display element may be assigned to each connection point. It is also possible for the connection points to have several pins in order to transmit electrical signals to the component and/or receive them from the component. It is possible for an operating current to be provided for the component in this way and/or for data to be exchanged with the component. It is also possible that components such as actuators or sensor technology themselves do not have an interface to a bus system, but that the connection module may be controlled via the bus system to control and/or read out a component via the connection point.

The components are preferably designed as electrical components, each of which may perform a task for the operation of the machine. For example, the components may comprise installation elements, such as cables or the like, for electrically connecting an actuator and/or a sensor and/or another component to the connection module. The components may also comprise at least one component and/or at least one sensor and/or at least one actuator. A connection module may also be referred to as a component. It is also conceivable that connection modules are interconnected, for example in the structure of a master-slave circuit. The components may therefore also include other connection modules. In this case, this may be referred to as a module-module or module-hub-point connection, for example. The connection modules may also include a hub accordingly. It is also possible for the connection modules to comprise master modules and slave modules, so that a master-slave connection may be possible. The connection modules may enable a decentralized and modular connection of components such as installation elements.

Decentralized may refer to the fact that the connection modules at least partially replace a central control cabinet in that the connection modules only provide part of the connections for the machine, but enable these connections to be made decentrally in the field. In the case of a central topology, e.g. a centralized control cabinet concept, this may be referred to as a point-to-point connection, i.e. the starting point, the connection and the end point are clearly defined. In contrast, in decentralized applications it is possible, or may even often be necessary, to arrange or connect several components between the starting point and the end point.

In principle, the following components may be provided for a machine, for example: Devices such as actuators and/or sensors, the connection modules, installation elements, e.g. for cabling.

The method according to the invention may comprise the following steps, which are preferably carried out one after the other or in any order, wherein the steps may also be carried out repeatedly and/or automatically and/or may be provided for further connection modules of the machine:
Providing an installation function of the connection module for the installation of the machine, preferably individual components, wherein the installation function may initiate an output, preferably optical, of an installation information for supporting an establishment of the connection of the components,
Providing an operational function of the connection module for an operation of the installed machine, wherein the operational function may initiate an electrical output to the connected components, preferably to the components which are properly connected to the connection module,
Initiating an installation mode on the connection module, wherein the operational function is deactivated and the installation function is activated.

In other words, in installation mode, the operational function may be automatically deactivated and the installation function activated to provide support for establishing the connection for installation instead of the electrical output for operating the installed machine. In this way, the connection module itself may help to support a user in installing the machine and thus simplify the installation and make it safer. The method steps may be carried out at least partially or completely by the connection module itself, e.g. by a firmware of the connection module. The initiation of the installation mode (and the associated deactivation or activation of the functions) may be triggered externally, e.g. by an installation device such as mobile computer with software to support and guide the user during installation. The triggering may be made possible, for example, by a data and/or electrical connection between the installation device and the connection module. The triggering may also be provided by a connection to the power supply, so that a separate data connection is not necessarily required for this.

The installation function may be provided as a support function for establishing the connection and thus for the installation. Another support function for the installation may be a test function that checks whether the connection has been established completely and/or in accordance with an installation specification.

For example, it is possible for the test function to detect the presence of an error such as an installation and/or connection error in a test mode of the connection module. For this purpose, the test mode and the test function may be initiated automatically or manually after the component has been connected to the connection module. The error may be, for example, a connection of the correct component to the wrong connection point or the connection of the wrong component to the correct connection point. Thus, it is possible that a user incorrectly connects the component in the form of an actuator to a connection point of the connection module, which is incorrectly designed as an input and not (as it should be) as an output. It is also possible that a user incorrectly connects the component in the form of a sensor technology to a connection point of the connection module, which is incorrectly designed as an output and not (as it should be) as an input. It is also conceivable that the user connects such a component to a connection point that is not intended for this connection point according to the installation specification. It is also conceivable that the connection is mechanically and/or electrically incomplete. In these cases, the connection, i.e. the connection of the component to the connection module, may represent a fault that may be detected by the test function. For this purpose, the test function may advantageously initiate a signal and/or data exchange with the component via the connection point in order to determine which component is connected to the connection point. For example, the component sends information such as a name about its identity to the connection module. The connection module may then transmit this information to an installation device, if necessary, so that the information is matched with the installation specification. If the error is detected based on the comparison, this may be communicated to a user via the test function using the optical output. For this purpose, for example, a color output may be provided via at least one display element as an optical output, e.g. in red, yellow and green or other colors. The optical output in test mode may therefore be used to display the result of the detection and thus the check.

It is conceivable that the test mode is automatically initiated after the installation mode when the component has been connected to the connection module. In this way, the test function may be activated automatically after the connection has been established. For example, the initiation of the test mode may be triggered by a user acknowledging the establishment of the connection and thus the execution of the installation activity, e.g. by a user input. This user input may be made, for example, on a computer such as the installation device and/or by an input device such as a touch screen and/or an electronic item of clothing such as a glove.

It is also possible for the test function to detect a deviation from the installation specification, in particular a deviating connection of a component to the connection module, preferably to a deviating connection point. The deviating connection may then be documented in the installation specification and/or the connection module may be reconfigured based on the detected deviation. For example, if the user has incorrectly connected an actuator to an input as a connection point, this may be detected by the test function and the input may be reconfigured to an output or hybrid connection on the connection module. In other words, once the deviation has been detected, the connection point may be reconfigured using software while maintaining the physical connection.

The optical output may be used in installation mode to output the installation information. Furthermore, the optical output may be used in an operational mode of the connection module to provide the operational function. For example, in operational mode—e.g. after a complete test and fault-free operation of the machine—the optical output may represent a current signal status of an assigned connection point. The signal status refers to the status of the electrical output and preferably indicates whether the electrical output is currently present via the connection point. The signal status may be defined in the operational mode (in particular exclusively) via a control device. It is also possible for the control device to receive diagnostic messages from the connection module in the event of a fault. To represent the signal status, a display element may, for example, light up in different colors, e.g. red, yellow and green. In the installation mode, on the other hand, the connection point, preferably the pins at the connection point, may not carry an electrical signal. The respective display element may then indicate where the component, e.g. a connecting element such as a plug connector, should be connected. Preferably, the visual output from the display elements already indicates that the connection module is in installation mode (e.g. by flashing or different colors).

Switching to installation mode may also have the advantage that a link between the optical output and the electrical output may be used flexibly. It is also possible for further installation functions to be provided via the optical output in installation and/or test mode. Some installation functions are mentioned below as examples. For example, the optical output may be used to show free connection points for connection to a component. It is also conceivable that the connection point used for the connection is then automatically documented accordingly, e.g. in the installation specification. In addition, the connected component such as a device, e.g. an actuator or sensor, may be automatically recognized in test mode. Based on this detection, connection points may be reassigned if necessary and this may be documented accordingly, e.g. in the installation specification. It is also possible that components do not have to be permanently connected to the connection point provided for this purpose in accordance with the installation specification, but if the connection deviates from this, this is subsequently modified in the installation specification depending on the detection. The respective installation function may be provided at least in part by an installation device that is in data connection with the connection module.

Within the scope of the invention, it may be provided that the connection module has at least one display element in order to provide an indication for the operational function. The at least one display element may be assigned to a respective connection point of the connection module for the connection with a respective component to be connected. The display element is, for example, an electrical component such as a light-emitting diode. Furthermore, the method, in particular for establishing the connection of the components in installation mode, may comprise the following step: Initiating an activation of the display element by the installation function to output the installation information to indicate the connection point for the respective component to be connected. Thus, the installation information may be a support and/or an installation instruction to indicate to a user to which connection point the component to be connected should be connected.

Of further advantage, it may be provided that the initiation of the activation of the display element is based on the following steps to initiate the output of the installation information based on a received identifier and an installation specification:
Providing the, in particular digital, installation specification, which specifies an assignment of the connection module and other spatially decentralized connection modules of the machine with the components,
Receiving the identifier, in particular the digital identifier, of the respective component to be connected, wherein the component is provided in the form of an installation element, preferably a cable or a component, or another component, wherein the identifier is preferably received by a detection device which has previously read in a physically present means for identification, such as a machine-readable code, and has generated the identifier based on the read-in means for identification,
Identifying the respective component to be connected and/or the connection module assigned to the connection using the installation specification provided, preferably by querying the electrical component and/or the connection module from the installation specification using the identifier, preferably from a list and/or database of the installation specification.

Subsequently, the output of the at least one installation information based on the received identifier and the identified component and/or the identified connection module may be provided, preferably comprising a visual and/or acoustic output to a user. Thus, the method enables easier, faster and error-free assignment of connection modules to components and/or vice versa and may thus significantly support a user for the installation of the machine and simplify the process. Furthermore, in this way a support system for installation, in particular for wiring, may be provided spatially directly at the identified component for guided orientation of the user, in which an installation device may carry out the method steps automatically if necessary. The installation device, in particular an apparatus for data processing according to the invention, may advantageously communicate with individual connection modules and thus enable the output of the installation information. For this purpose, the installation device may have at least one interface for communication.

In a further possibility, it may be provided that the method further comprises the following step: Providing a test function for testing the establishment of the connection and/or a function of the components and/or the operational function and/or a connection state of the connection, wherein preferably the test function initiates the electrical output to the respective connected component. The test function may be provided, for example, in a test mode of the connection module. The connection module may thus have three different modes: an operational mode in the sense of a production phase, an installation mode in the sense of an installation phase and a test mode in the sense of a test phase or “IO check phase”. The test function may, for example, include an activation of the ports of the connection points even without a connection to a control device in order to enable an elementary functional test of the connected component. For example, it is checked whether a sensor is connected to the input and/or an actuator is connected to the output. A result of the test may be output by the optical output, e.g. via a display element. For example, colors such as red may indicate an error.

It may also be advantageous if, within the scope of the invention, the method comprises the following further step: Determining a connection state between the connection module and the component in order to determine whether the connection has been established. For this purpose, for example, an electrical connection test may be carried out, by means of which it may be automatically determined whether the connection module and the component have an electrically conductive connection. Depending on the design, it is conceivable that a circuit is not yet immediately closed during the connection, especially if the installation has not yet been completed. Therefore, additional or alternative ways of determining the connection state may also be provided. Thus, determining the connection state may further include: Receiving an installation message based on an input from the user and/or from the connection module. The received installation message may indicate that the connection of the connection module with the component, preferably with an indicated connection point, has been established. Accordingly, it may be checked that the connection point that was displayed has actually been connected to the component. It is possible for a documentation to be triggered by establishing the connection, e.g. by manual acknowledgement by a user and/or automatic acknowledgement by establishing the connection if, for example, both sides of a cable have been connected. Installation documentation, for example, is stored in the documentation. This documentation may be executed repeatedly, e.g. each time an activity is acknowledged, in order to gradually build up the installation documentation. In order to make the installation information visible to the user on the one hand and to be able to document the work carried out on the component on the other, it is advantageous that an installation device may communicate with the connection modules. Following the installation and/or documentation, the control device may optionally be programmed and/or the connection modules configured based on the documentation. Due to this circumstance, it may be possible that the connection module does not know beforehand what task it will have to perform in the future machine. This may also be referred to as “unconfigured”.

A further advantage within the scope of the invention may be achieved if the operational function initiates the electrical output in the form of an output of an electrical current and/or an electrical voltage to the components. In this case, the electrical output may be provided at connection points of the connection module for connecting the components in order to operate the components connected to the connection points. This has the advantage that the connection module enables electrical interconnection of components in operational mode.

It is also advantageous if the deactivation of the operational function is carried out in order to prevent the respective component to be connected from being operated during installation. In this case, the electrical current and/or the electrical voltage at the respective connection point may at least be reduced in installation mode, in particular in such a way or to such an extent that the operation of the corresponding component is prevented or reduced to a safe level. This has the advantage that the component is not operated unintentionally during installation. It is possible to dispense with this reduction in operational mode.

Furthermore, within the scope of the invention, it may be provided that after a completion of the installation, the installation mode is exited and an operational mode for providing the operational function is initiated. In this way, the regular function of the connection module may be provided.

Advantageously, the invention may provide that the connection module comprises at least one display element to provide a display or indication for the operational function. The display element comprises, for example, a light source such as a light-emitting diode or the like. It is also possible for the display element to have exactly two light states (on and off), with a light mode adapting these light states in terms of frequency and/or color if necessary. Furthermore, the display element may be arranged on a housing of the connection module in such a way that the display element is visible from the outside by a user. The at least one display element may be assigned to at least one connection point of the connection module, e.g. by being arranged on the housing adjacent to the connection point. It is also possible that in operational mode, the display element lights up in a different light mode, such as a different color and/or a different flashing frequency and/or a different brightness than in installation mode. In this way, the operational mode and/or the operational function may be clearly signaled and visually distinguished from the installation mode or the installation function. A function may already be provided in operational mode so that faults are detected repeatedly and the fault, such as a cable break, is indicated by means of the display element. In installation mode and/or test mode, this function may not be used, but instead the display element may be used for another function, in particular for the installation and/or test function.

Furthermore, it may be provided that the electrical output is provided at connection points of the connection module for connecting the components. In this case, the electrical output at the connection points may be defined in operational mode by a control device outside the connection module, preferably a PLC. In installation mode, on the other hand, the electrical output at the connection points may be defined by an installation device outside the connection module and the control device. Preferably, a functional connection to the control device for controlling the components via the connection points is active and/or configured in operational mode and inactive and/or unconfigured in installation mode.

It is also optionally conceivable that the installation mode is signaled by at least one display element of the connection module in order to visibly distinguish the installation mode from the operational mode by means of the at least one display element. A different light mode is used for this purpose, for example.

It is also advantageous if the components comprise at least one connecting element and/or a cable and/or a component and/or an actuator and/or a sensor and/or a further connection module. For example, the components may be designed as actuators and/or sensors, which are operated in operational mode by the electrical output. The actuator may, for example, be motor or the like.

may optionally be provided that an initiation of an activation of a display element of the connection module by the installation function for outputting the installation information is synchronized with an output of a further installation information in the form of an installation instruction for assisting a user with the installation. In this context, the output of the further installation information may comprise at least one of the following steps:
Initiating a display of a connection point, in particular a slot, of the electrical component for the installation element on a user interface of a computer, wherein the user interface visualizes a digital twin of at least a part of the machine, and preferably visualizes a mechanical and/or an electrical structure of the part of the machine,
Initiating an indication of a connection point, in particular a slot, of the electrical component for the installation element by means of augmented reality and/or by means of an item of clothing such as a glove and/or by means of a detection device and/or by means of an optical and/or acoustic signal,
Initiating an output of the installation instruction as an instruction for the user to connect the installation element to a specific connection point of the electrical component, preferably determining the connection point based on the installation specification,
Initiating an acoustic output, in particular a voice output, of the installation instructions.

This enables the user to be informed directly by the installation instructions as to how the component is to be connected, i.e. connected to the connection module. For example, the connection point to which the component is to be connected may be indicated by the display element lighting up. Furthermore, the lighting up of the display element may make it possible indicate a correctly or incorrectly assigned connection point accordingly. For this purpose, the connection module may comprise several of the display elements, which are assigned to corresponding connection points, e.g. through an adjacent arrangement on a connecting element.

It is conceivable that the installation information is output by a visual and/or acoustic and/or mechanical signal and/or by a vibration. For example, it is possible that in installation mode and/or test mode, the installation and/or test function detects that a component is connected to the wrong connection point. This may be signaled by the installation information. Alternatively or additionally, a correct connection may be signaled in the same way. The installation information may, for example, be binary information (e.g. correct connection or incorrect connection). The installation information may also include further information, e.g. an indication of which connection point would be the correct one according to the installation specification. Text information and/or a graphic may also be output for this purpose, for example. The installation information may also be displayed on a screen. It is also conceivable that the installation information is output via a vibration or similar, e.g. via an item of clothing such as a user's glove. It is particularly advantageous if the detection device is integrated into this item of clothing in order to scan an identifier over it.

Another object of the invention is a connection module for a decentralized and modular connection of components of a machine, wherein the connection module is designed to carry out the steps of a method according to the invention. The connection module according to the invention thus has the same advantages as those described in detail with reference to a method according to the invention.

A user may be, for example, an installer and/or plant mechanic and/or electrician and/or worker and/or planner and/or mechanical designer or developer and/or electrical designer or developer and/or PLC programmer and/or commissioning engineer and/or maintenance engineer and/or machine operator. It is possible for the user to use the method according to the invention by providing the method to the user via a computer. For this purpose, a computer program may be executed at least partially by the computer and/or by the connection module and/or by another computer in order to perform the method steps according to the invention.

Furthermore, it is possible for several users to use the method according to the invention simultaneously or at least partially simultaneously. Accordingly, the steps of a method according to the invention may also be carried out several times and/or at least partially in parallel, preferably for different connection modules. For example, the steps are carried out at least partially simultaneously for at least two or at least three or at least four users.

Several components such as installation elements may be provided for the installation of the machine. These components may each be assigned an identifier by which the components may be uniquely identified. The identifier may be information that may be processed digitally, for example. The respective component may comprise the identifier in that a physical means for identification is provided and/or attached to the component. The components may be, for example, cables or components that are a functional part of the machine. The identifier advantageously comprises a unique and, in particular, unambiguous labeling. This makes it possible to uniquely identify the component using the identifier in connection with the machine and/or other machines and/or the installation of the machine. One or more pieces of information about the component may be assigned to the identifier. The at least one piece of information may include at least one of the following: at least one piece of status information, the output installation information, a labeling of the identified connection module, at least one of the documentation specifications described in more detail below, such as component type, machine type, system type, user, connection point designation, time stamp date and time, installation duration, address in a bus system, equipment identification, cable length, port assignment, properties of the open cable, temperature, humidity, current project status during installation, deviation from plan and reason. A digital storage of the at least one piece of information assigned to the identifier thus makes it possible to create a digital twin of the component. In this way, a passive smartification of the component may be enabled.

Smartification refers in particular to the addition of intelligent properties to an industrial product such as a component and/or a part and/or an installation element such as a cable. Information technologies may be used to enable connection modules to process data and offer additional added value. Passive smartification may be provided as a corresponding preliminary stage by means of a passive intelligent component such as an NFC chip (near field communication, abbreviated NFC) and/or a machine-readable code. This may provide a basis for automated recording or for changes and their effects on the function of a machine. The unique, preferably one-to-one labeling in conjunction with access to an external database may enable the active enrichment of information and thus passive smartification.

In particular, devices of the machine such as actuators and/or sensors are operated, i.e. preferably controlled and/or read out, via the installation elements. A control device such as a PLC (programmable logic controller) may be provided for operating the devices, which may carry out the electrical operation of the devices via the installation elements and connection modules. For this purpose, the control device may be electrically connected to the connection modules.

Preferably, the installation element may comprise a cable and/or a component, wherein the cable may have at least or exactly one connector, and may preferably be assembled on one side, i.e. have a female or male connector on one side and an open end on the other side.

Alternatively, the cable may also be assembled on two sides, i.e. the cable has a female or male connector on each side.

It may also be possible that the at least one installation information comprises an installation instruction to assist a user, such as a worker and/or installer, with the installation. The installation instruction may also include instructions for the installation, e.g. step-by-step instructions.

The connection point, in particular a connection port, which may be provided in accordance with the installation specification for connecting the component with the received identifier, may be queried, for example, via the received identifier from the installation specification. For this purpose, the installation specification may enable an electronic query, e.g. by means of a database and/or a list and/or the like.

The display of the connection point on the user interface may include, for example, a graphical representation of the connection points of the component, wherein the connection point that is intended for the connection of the component with the received identifier is graphically highlighted.

The user interface may be a graphical user interface that is displayed on a screen, preferably of an installation device such as a computer. The computer may be, for example, a portable computer such as a laptop or tablet.

The indication by means of augmented reality may be achieved, for example, by using VR (virtual reality) glasses by a user to display additional information and/or by recording the user's surroundings by a camera and processing the camera image to include additional information in the camera image. The additional information includes, for example, highlighting the connection point when the physical connection point of the connection module is visible in the camera image.

Furthermore, an acoustic output may also be provided, which includes, for example, the activation of a loudspeaker. The acoustic output may, for example, be a voice output through which the connection point designation is spoken.

A further advantage within the scope of the invention is achievable if the method comprises the following further steps:
Verifying the connection, preferably the connected connection point, using the installation specification, preferably a predetermined digital circuit diagram and in particular an electrical connection diagram, in particular in order to determine whether a user has correctly implemented the installation information in the form of an installation instruction, wherein preferably a labeling for the installation specification is stored as a function of the verification, and particularly preferably the subsequent step is carried out in the event of a positive verification:
Storing the labeling of the connection point as a correctly connected connection point in the installation specification.

Advantageously, the verification may be carried out based on determining the connection state. The verification thus makes it possible to assess whether the user has followed the installation instruction correctly. The result of the verification may be used to store the labeling in the installation specification. This means that the installation specification may be used at a later point in time to check whether the installation specification was followed and/or to what extent the installation specification was deviated from during installation.

Should a user deviate from the installation instruction, this is often for a relevant reason or occasion. Therefore, a user may be provided with the ability to enter an installation parameter, for example, via the user interface and/or an input device such as a voice input and/or a keyboard and/or a mouse and/or an electronic item of clothing and/or a touch screen. Advantageously, in the event of a negative verification, i.e. if the user has not correctly implemented the installation instructions, at least one of the following steps may be carried out: Storing a labeling of the connection point as a changed connected connection point in the installation specification, preferably based on an installation parameter entered by the user, in particular an occasion or reason for the change, preferably including an indication of the occasion or reason for the change, and preferably: Initiating a correction of the connection according to the installation specification. The correction may, for example, include a modification of the installation specification if the new connection is justified and thus makes a beneficial contribution to the desired installation.

Optionally, it may further be provided that the method comprises the following further step, wherein the step is preferably performed when verifying the connection:
Validating the, in particular verified, connection with regard to a complete establishment of the connection, in particular a proper screw connection and/or power and/or data connection and/or contacting, preferably by means of a measured variable transmitted by an external test means, in particular a sensor or a test tool, in order to determine whether a user has complied with a predetermined measured variable.

This makes it possible to ensure that, depending on an installation environment, the respective valid or necessary requirements for the materials used or the connection are guaranteed. This also has the advantage of significantly reducing safety risks during the installation of machines. The specified measured variable may be a reference value, which is compared with the transmitted measured variable as the current measured value. The establishment of the connection may, for example, be considered correct and/or complete if the transmitted measured variable fulfills a predefined condition such as exceeding the reference value.

Further, it may be provided that the at least one installation information comprises an installation instruction for assisting a user in a reconstruction of the machine, preferably wherein initiating the output comprises at least the following step: Initiating an output of an installation sequence by means of the at least one installation information for the installation of the machine. The installation information may, for example, comprise installation instructions which also indicate an order of installation. This simplifies the installation for a user and speeds up the installation, since a time-consuming interpretation of a circuit diagram and, in particular, a connection diagram is no longer necessary, at least in part.

According to an advantageous further development of the invention, it may be provided that the initiation of the output comprises an initiation of a bidirectional communication with the identified connection module via a bus system. The output may be triggered, for example, by transmitting a specific message, preferably a command, to the connection module via the communication. For this purpose, for example, a computer program may be executed by a data processing apparatus, wherein the data processing apparatus is connected to the bus system.

Advantageously, the invention may provide that at least one of the following specifications is received, preferably by the installation message, to create a digital twin of the connection module and/or the electrical component based on the received identifier and the identified connection module: Component type, machine type, plant type, user, connection point identifier, timestamp date and time, installation duration, address in a bus system, equipment identifier, cable length, port assignment, open cable properties, temperature, humidity, current project status at installation, plan deviation and reason. The at least one specification may also be referred to as a documentation specification in the context of the present

### Invention.

The installation message may, for example, have been generated based on an input from a user, wherein the user may have indicated the at least one specification in the input. It is also possible for the specification to be determined automatically, e.g. by the component and/or a data processing apparatus, in particular based on the identifier received. For this purpose, for example, the at least one specification may be stored in the component and/or in the installation element and/or in the connection module.

In a further possibility, it may be provided that the installation information comprises an installation configuration and/or installation documentation, preferably for disassembly and/or reconstruction of the machine, which is stored for documentation, preferably stored in a data memory and/or transmitted to the electrical component. The data memory may be designed as a non-volatile data memory in order to reliably enable a later evaluation of the installation configuration and/or the installation documentation. The installation configuration and/or the installation documentation may, for example, include the stored labeling based on the verification.

A further advantage may be achieved within the scope of the invention if the installation information comprises a unique labeling which labels the component and/or the installation element and/or the identified connection module, wherein the installation information is stored in the installation specification, in particular in a digitized construction plan, preferably comprising ECAD and/or MCAD data, and/or wherein the component is selected from a plurality of similar components and/or the identified connection module is selected from a plurality of similar connection modules based on the identifier. The installation specification thus makes it possible to use the labeling and/or the identifier to query the assignment of the connection modules to the components. For this purpose, the installation specification may include a linking of the labeling with each other and/or with the identifiers. The identifier may optionally be uniquely assigned to one of the labelings of the components and/or the identifier may correspond to this labeling.

A further advantage within the scope of the invention may be achieved if the installation specification comprises a predefined specification of a modular and/or decentralized structure of the machine, in particular of the plant, preferably based on predetermined ECAD and/or MCAD data, in particular of an interconnection of the components such as installation elements in the form of cables and/or components by means of the connection modules, preferably comprising an electrical connection diagram, wherein preferably the installation specification is determined by linking the ECAD and MCAD data. The installation specification may thus comprise a digital circuit diagram and/or construction plan and/or installation plan of the machine.

It is also conceivable within the scope of the invention that the identifier is used to configure the connection module in order to transfer the connection modules from a basic configured state, in which the component is preferably configured for bidirectional communication by means of a bus system and/or a functional control by a control device, preferably a PLC, is excluded, to a state with an extended configuration for functional control by the control device.

In particular, the identifier received makes it possible to recognize which installation element has been (or is to be) connected to the connection module. This recognition may be used to automatically carry out a configuration of the connection modules required for the installation, which significantly reduces the configuration effort on a connection module during installation. For example, the identifier received and the installation specification are used to determine which of the connection modules is (or will be) connected to the installation element. Accordingly, the connection module may be configured for this installation element so that it is known to the control device that the installation element is connected to this connection module for subsequent functional activation by the control device. This enables the control device, for example, to operate at least one device of the machine, such as an actuator and/or sensor, via this connection module and/or the installation element.

Another object of the invention may be a system for a computer-aided installation of spatially decentralized electrical components of a machine, comprising a detection device, in particular a scanner such as a hand scanner or a camera, for providing an identifier of an installation element, preferably a cable or a component, further comprising at least one electrical component, preferably in the form of a connection module for connection to the installation element and further installation elements, and an apparatus for data processing, comprising means for carrying out the steps of a method according to the invention. The system according to the invention thus has the same advantages as those described in detail with reference to a method according to the invention.

In addition, an apparatus for data processing, preferably for the connection module, comprising means for carrying out the steps of a method according to the invention, may also be an object of the invention. The apparatus may be modified to communicate with the components, in particular modules, of the machine, in particular plant, preferably without the modules being preconfigured and/or connected to a control device.

Furthermore, it may be provided that the identifier is encoded in a machine-readable code assigned to the installation element, in particular arranged on the latter, the machine-readable code being machine-readable by means of the detection device.

Furthermore, it is possible that the connection module and/or the components and a computer and/or a control device are each connected to each other via a bus system for bidirectional communication, wherein the bidirectional communication is provided based on a communication protocol for a field bus system, in particular based on a ProfiNet, Ethernet/IP, EtherCAT or 802.3 standard, and/or the bidirectional communication is provided wired via a bus system or wireless by means of Bluetooth or WLAN, based on a standard according to IEEE 802.11 or based on a mobile radio telecommunications standard.

Another object of the invention is a computer program comprising instructions which, when the program is executed by a computer, such as the apparatus for data processing according to the invention, preferably the connection module, cause the computer to carry out the steps of a method according to the invention. Thus, the computer program according to the invention has the same advantages as described in detail with reference to a method according to the invention. The computer program may be implemented as a firmware of the connection module.

It is possible for several users to carry out the (same) method steps simultaneously and/or at least partially simultaneously. The simultaneous and/or at least partially simultaneous execution of (the same) method steps by several users is also referred to below as a multi-user application.

A further method for a computer-aided installation of spatially decentralized electrical components such as connection modules of a machine may also be an object of the invention, in which the installation is carried out simultaneously and/or at least partially simultaneously by at least two users.

In connection with a method according to the invention, in particular in a multi-user application and/or in the further method, a handover between the different users may be provided. In order to enable a handover between the, preferably both, users and to ensure an optimal process, a processing status of the respective user may be automatically and digitally documented in real time. This allows the two or more users to work simultaneously on different areas of the machine without jeopardizing the integrity of the electrical installation or having to carry out lengthy coordination processes.

It is advantageous that the current status of the installation is displayed in real time. Furthermore, an installation instruction may be assigned to the respective user and digitally documented. In this way, relevant information may be collected during the installation process. The information collected includes, for example:
A user-specific labeling and role (access and editing authorizations, qualification level if applicable), and/or
A last used connecting element and/or a last used component and/or a last used part, and/or
A last machined point, in particular a segment, of the machine to which the last connection module and/or component and/or component used was attached, and/or
A last user (unique user ID) and the time of the user's last edit, and/or;
A last identified connecting element, preferably a scanned component, and a machine area for which the connecting element or component is intended.

It may be provided that at least two users carry out the installation of spatially decentralized electrical components, preferably connection modules, of a machine. Each user may log in via the user interface of a computer, preferably a portable computer, and then select, for example, a work order to be processed in order to start the installation. Selecting a work order or installation instruction locks it for the other users. Each user may log in and make their selection on their own computer. The computers are connected to each other via a network and/or to a server, for example, in order to synchronize the selection with each other.

### BRIEF DESCRIPTION OF THE DRAWINGS

For a better understanding of the disclosure, reference is made to the following drawings:

FIG. 1: A central connection in a machine by means of a control cabinet.

FIG. 2: A decentralized connection according to embodiments of the invention.

FIG. 3 A schematic representation of parts of a system according to embodiments of the invention.

FIG. 4 A schematic representation of details of a method according to embodiments of the invention.

FIG. 5 A schematic representation of steps of a method according to embodiments of the invention.

### DESCRIPTION OF THE EMBODIMENTS

Planning, installing and setting up machines and electronic automation technology is a complex task. This applies to centralized control cabinet systems as well as decentralized systems in which control modules are attached directly to the plants. The corresponding processes are carried out by different people, such as plant planners, electrical planners, installers, system programmers, etc. A special feature of decentralized systems is the distribution of modules at different points on a machine compared to centralized control cabinet systems. For larger machines in particular, simultaneous installation, i.e. installation carried out by several users at the same time, may be advantageous for time and logistical reasons. To enable a smooth installation process, the work status should be documented automatically, user-specifically and digitally in real time. For various reasons (e.g. maintenance planning, system diagnostics), it is important to have complete documentation of all relevant information throughout the entire plant life cycle.

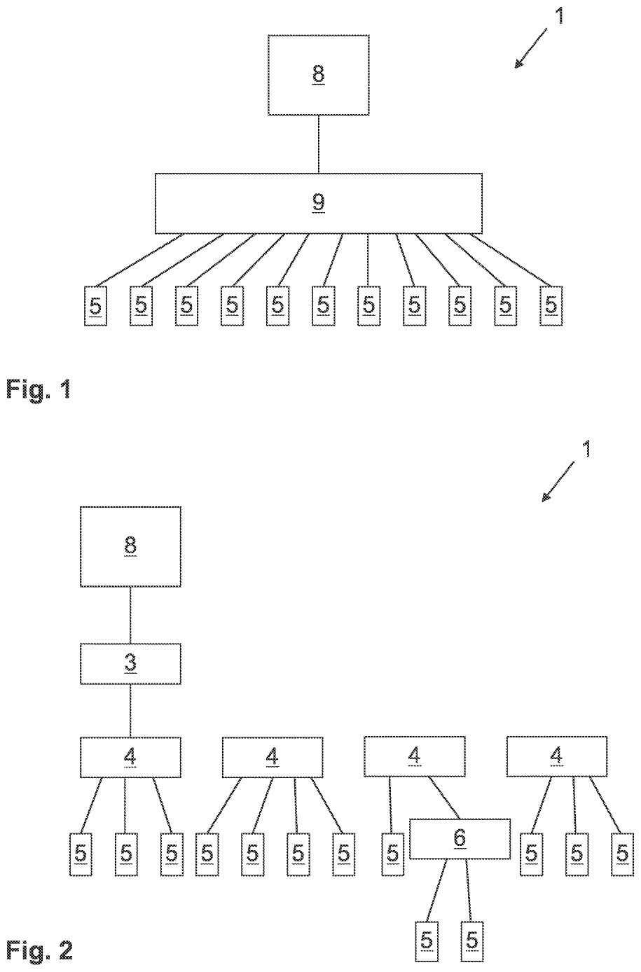

FIG. 1 schematically shows a centralized connection using a control cabinet 9 in order to contrast this with a decentralized connection using spatially decentralized electrical connection modules 4 of a machine 1 in FIG. 2. Instead of connecting all devices 5 such as sensors and actuators directly to the control cabinet 9 as shown in FIG. 1, several connection modules 4 may be used in the decentralized connection in FIG. 2. Like the control cabinet 9, these enable the devices 5 to be coupled with a control device 8 such as a PLC. However, the connection modules 4 may be decentralized and distributed in the vicinity of the devices 5. The connection modules 4 thus only partially interconnect the devices 5, with the connection modules 4 together or, for example, one and/or more connection modules 4 each performing the entire interconnection via one and/or more hubs 6. In order to enable the configuration and/or control of the connection modules 4 centrally, a master module 3 may be connected upstream of several of the individual connection modules 4. It is also possible for the interconnection to be further subdivided by means of at least one hub 6.

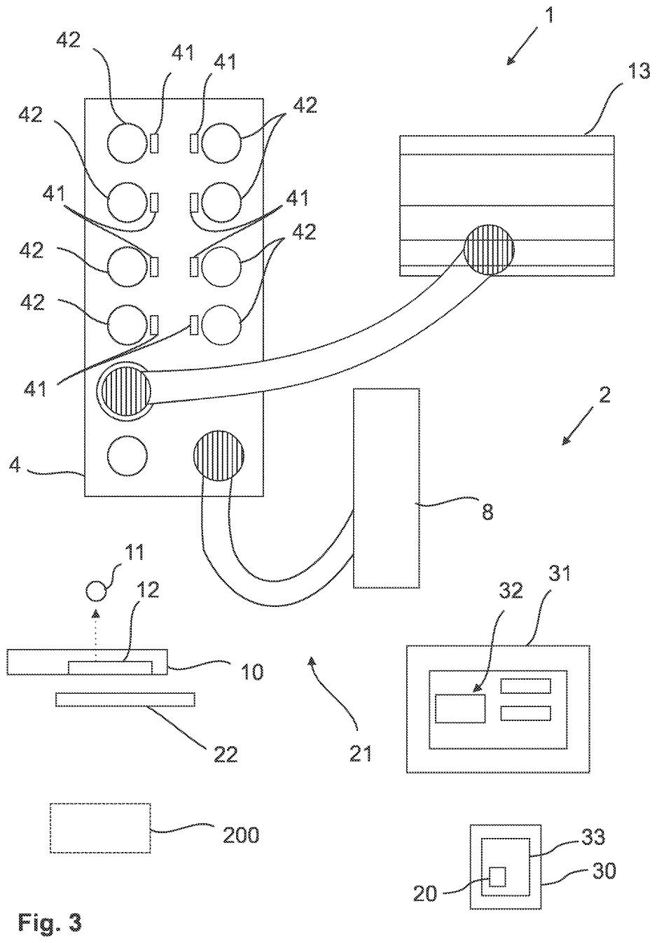

FIG. 3 shows parts of a system 2 according to embodiments of the invention, which may be provided for a computer-aided installation of spatially decentralized electrical connection modules 4 of a machine 1. The system 2 may comprise a detection device 22, in particular a scanner 22 or a camera 22, for providing an identifier 11 of an installation element 10, preferably a cable 11 or a component 11. Furthermore, the system 2 may comprise at least one electrical connection module 4 for connection to the installation element 10 and further installation elements 10. Likewise, a data processing apparatus 30 may be part of the system 2, wherein said data processing apparatus 30 may comprise means for carrying out the steps of a method 100 according to embodiments of the invention.

The identifier 11 may be encoded in a machine-readable code 12 associated with the installation element 10, in particular arranged thereon, wherein the machine-readable code 12 is designed to be machine-readable by means of the detection device 22. It is thus possible for a user to scan the code 12 by means of the detection device 22 and thus transmit the identifier 11 to the data processing apparatus 30.

Furthermore, the connection modules 4 and at least one computer 30, 31 and/or a control device 8 may each be connected to one another via a bus system 21 for bidirectional communication, wherein the bidirectional communication may be provided based on a communication protocol for a field bus system, in particular based on a ProfiNet, Ethernet/IP or 802.3 standard, and/or the bidirectional communication may be wired via a bus system 21 or wireless by means of Bluetooth or WLAN, based on a standard according to IEEE 802.11 or based on a mobile telecommunication standard. In order to enable operation of the connection module 4, the connection module 4 may also be connected to a power supply 13.

Further shown is a computer program 20 comprising instructions which, when the program is executed by a computer 30, cause the computer 30 to perform the steps of the method 100 according to embodiments of the invention.

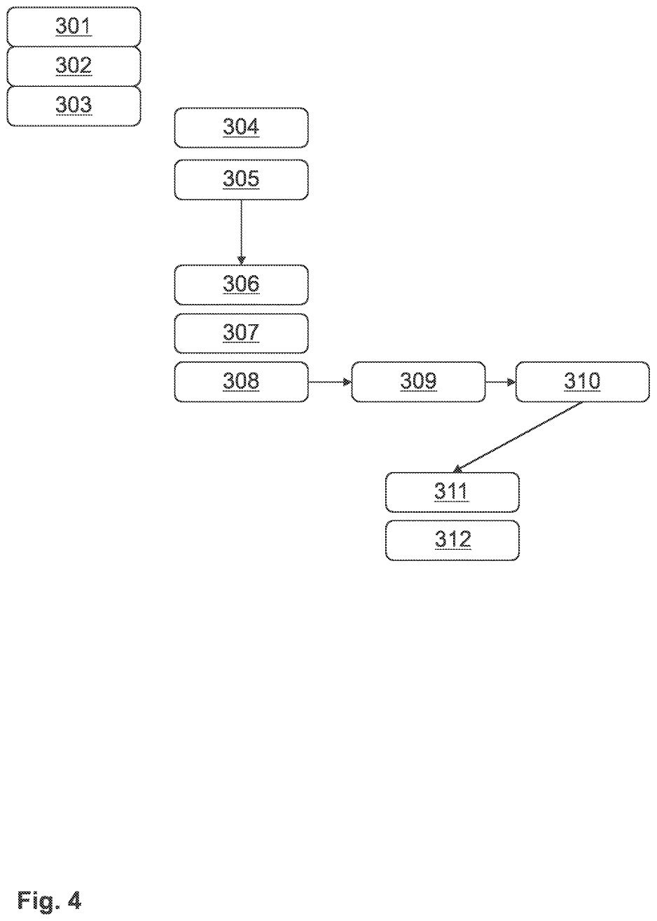

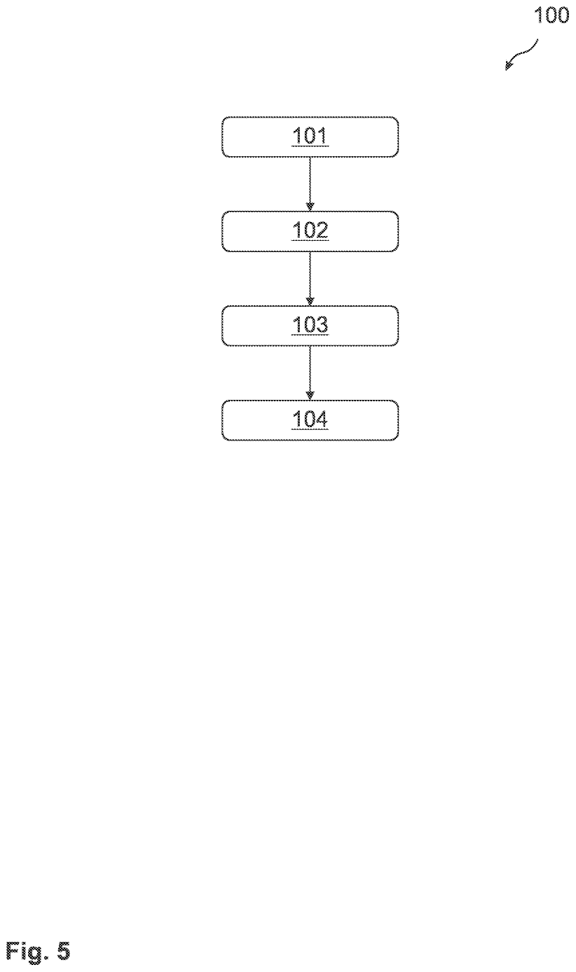

In FIGS. 4 and 5, method steps of the method 100 according to embodiments are visualized. Specifically, FIG. 5 illustrates a method 100 for operating a connection module 4 in a computer-aided installation of a machine 1. Here, the connection module 4 may be designed for a decentralized and modular connection of components—such as the installation elements 10—of the machine 1. According to a first method step 101, an installation function of the connection module 4 for the installation of the machine 1 may be provided, wherein the installation function initiates an output of an installation information for supporting an establishment of a connection of the components. The output of the installation information may comprise an initiation of an optical output. Subsequently, according to a second method step 102, a provision of an operational function of the connection module 4 for an operation of the installed machine 1 may be provided, wherein the operational function initiates an electrical output to the connected components. Then, according to a third method step 103, an installation mode may be initiated at the connection module 4, wherein the operational function is deactivated and the installation function is activated. After the connection has been established, it is also possible that a test mode is initiated according to a fourth process step 104, in which a test function is executed in order to check that the connection has been properly established.

The method 100 may further provide at least one of the following support options:
Support for the user during installation, in particular wiring, preferably by the installation function and/or by a test function,
Support for the user in documenting the installation,
Support for the user during testing/automated testing, preferably the output of installation information,
Support for the user during disassembly,
Support for engineering during planning,
Support for the PLC programmer.

Initiating the optical output may comprise initiating an activation of a display element 41 shown in FIG. 3 on the electrical component 4 in order to indicate a connection point 42, in particular a slot 42, for the installation element 10 to be connected by the display element 41 in installation mode. Alternatively or additionally, initiating the output may comprise initiating an indication of a connection point 42, in particular a slot 42, of the connection module 4 for the installation element 10 on a user interface 32 of a computer 31. The user interface 32 may thereby visualize a digital twin of at least a part of the machine 1, and preferably a mechanical and/or an electrical structure of the part of the machine 1. Further alternatives or additional output possibilities include an indication of a connection point 42, in particular a slot 42, of the connection module 4 for the installation element 10 by means of extended reality and/or an output of the installation instruction as an instruction for the user to connect the installation element 10 to a specific connection point 42 of the connection module 4, the connection point 42 being preferably determined based on the installation specification 200. In addition, an acoustic output of the installation instruction may also be provided so that a user may follow the installation instruction without looking at the computer 31. Here, for example, a labeling of the connection module 4 and/or the corresponding connection point 42 is output verbally.

It is also possible that the installation information comprises an installation configuration and/or installation documentation, which is stored in a data memory 33 and/or transmitted to the connection module 4.

In order to avoid errors in the documentation that may occur when entering information manually, automated storage in the system may be advantageous. For example, all information is stored in the correct place in the various documents of the installation specification, such as the circuit diagram or the connection diagram. The person carrying out the respective step then only has to confirm the entries, e.g. via an input device such as a touchscreen and/or an electronic item of clothing.

The relevant information that may be included in the installation documentation includes, for example:
Which component was used (unique, preferably one-to-one labeling)?
On which machine and at which point on the machine was the specific component attached?
Who connected it and when?
To which port or connection point was the cable connected?
How was the cable connected?
Has the component been connected properly?
Were there any deviations from the plan?

The installation documentation may be used, for example, to document at least one of the following pieces of information: Work steps of the user with additional information on the work steps such as a processing time, which machine is being worked on, which user, for example which installer or fitter, carried out the activities and when, which component has been wired and/or cabled, has the installation step been completed, which port/connection point was used, do open cables exist and what are the properties of the open cable, e.g. length, environmental parameters, e.g. temperature, humidity, current project status, protection class, e.g. IP67. The user, in particular the worker, may also enter the reason for the deviation from the plan in the event of deviations from the plan. The installation documentation may be stored in a database, for example. If necessary, a user may trigger the documentation with physical actions (keystroke, screen, double-click).

Furthermore, an evaluation unit may be provided which evaluates the documented information, preferably the processing times of the user for the respective work steps. An artificial intelligence method may also be used for this purpose, which optimizes the results of the evaluation unit, for example. The results show the user potential for optimization in order to make a machine more efficient in the future, to optimize components or assemblies and to improve assembly and disassembly processes. The comments are also taken into account in the event of deviations from the plan.

It is also possible for the documentation to function with a connection module 4 that is not preconfigured or connected to a PLC. This avoids errors that may arise from using connection modules 4 that are externally identical but configured differently. Thanks to the communication capability of these components and the integration of all relevant information, the system may also be used to guide the user through the installation of the automation technology. The systematic collection and documentation of all relevant information, such as the components used, the execution of installation and maintenance tasks or problems that have occurred, also leads to reliable knowledge about the current system status. By automatically collecting and assigning this information, the process is significantly accelerated and human installers are relieved of the documentation task. The automated collection and storage of information to be documented may significantly reduce the risk of missing and/or incorrect documentation.

In FIG. 4, a method 100 according to embodiments of the invention is visualized with further details. Via an installation device 31 shown in FIG. 3, i.e. a computer 31, such as a tablet or laptop, a user may first perform a user login 301. For this purpose, the user may use a graphical user interface 32, which is provided by the computer 31. A project selection 302 may also be made via the user interface 32, by which, for example, an installation specification 200 for a desired project is loaded. This makes it possible to initiate a start 303 for instructions for the user to install the machine 1 by means of at least one installation instruction.

Optionally, after the start 303, a representation 304 of the last step performed, for example the last installation instruction and/or another instruction for the installation, may be performed first. First, an identification 305 of an installation element 10 may be performed by the user, wherein the user uses, for example, a detection device 22 such as a handheld scanner to scan a means for identification 12 on the installation element 10. Based on the scanned means for identification 12, the identifier 11 may then be determined and transmitted to the computer 31 and/or an apparatus 30 for data processing. Based on the identifier 11 received and the installation specification 200, the connection module 4 and the connection point 42 to which the installation element 10 is to be connected may then be identified. For this purpose, the installation specification 200 comprises, for example, a matrix in which various installation elements 10 are assigned to the connection modules 4. The user may then be informed by the installation instructions which of the connection modules 4 has been identified. For this purpose, for example, a display element 41 on the connection module 4 lights up. This may be enabled by a signal transmission 306 from the data processing apparatus 30 to the connection module 4. The user may then establish a connection 307 between the installation element 10 and the connection module 4. Based on the installation specification 200, a confirmation 308 of correct assembly may be made. Subsequently, at least partially automated documentation 309 of the correct assembly and documentation 310 of the completion of the work step in the installation specification 200 may be possible. This may be done, for example, by a displaying 311 in a machine overview with a green check mark or, for example, by showing the affected connection in an electrical circuit diagram and displaying it to the user via the user interface 32. An identification of an installation element 312 may then be carried out again. By guiding the user, in particular the worker, during the installation of the electrical automation technology and by automatically checking whether a suitable component has been properly connected, error-free production of the system 2 may be ensured.

The user may then establish a connection between the installation element and a device, such as an actuator and/or a hub and/or a sensor (not shown). The installation specification 200 may be used to confirm correct installation. Subsequently, at least partially automated documentation of the correct assembly and documentation of the completion of the work step in the installation specification 200 may be possible. This may be done, for example, by a representation in a machine overview with a green check mark or, for example, by showing the affected connection in an electrical circuit diagram and displaying it to the user via the user interface 32. These work steps correspond in principle to work steps 307 to 311.

Although some aspects have been described in connection with an apparatus, it is clear that these aspects also constitute a description of the corresponding method, wherein an element or apparatus corresponds to a method step or a feature of a method step. Similarly, aspects described in connection with a method step also constitute a description of a corresponding block or element or feature of a corresponding apparatus.

Embodiments of the invention may be implemented on a computer system. The computer system may be a local computing device (e.g., personal computer, laptop computer, tablet computer, or cell phone) having one or more processors and one or more storage devices, or a distributed computing system (e.g., a cloud computing system having one or more processors and one or more storage devices distributed in different locations, such as at a local client and/or one or more remote server farms and/or data centers). The computer system may comprise any circuitry or combination of circuitry. In one embodiment, the computer system may comprise one or more processors of any type. As used herein, the term “processor” may refer to any type of computing circuit, such as a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), a multicore processor, a field programmable gate array (FPGA), or any other type of processor or processing circuit. Other types of circuitry that may be included in the computer system may be a customer specific circuit, an application specific integrated circuit (ASIC), or the like, such as one or more circuits (e.g., a communication circuit) for use in wireless devices such as cell phones, tablet computers, laptop computers, two-way radios, and similar electronic systems. The computer system may include one or more storage devices, which may include one or more storage elements suitable for the particular application, such as a main memory in the form of a random access memory (RAM), one or more hard disks, and/or one or more drives that handle removable media such as compact disks (CD), flash memory cards, digital video disks (DVD), and the like. The computer system may also include a display device, one or more speakers, and a keyboard and/or control device, which may include a mouse, trackball, touch screen, voice recognition device, or other device that allows a system user to input information to and receive information from the computer system.

Some or all of the method steps may be performed by (or using) a hardware device, such as a processor, a microprocessor, a programmable computer, or an electronic circuit. In some embodiments, some or more of the key method steps may be performed by such a device.

Depending on specific implementation requirements, embodiments of the invention may be implemented in hardware or in software. The implementation may be carried out using a non-transferable storage medium such as a digital storage medium, for example a floppy disk, a DVD, a Blu-Ray, a CD, a ROM, a PROM, an EPROM, an EEPROM or a FLASH memory, on which electronically readable control signals are stored, which interact (or may interact) with a programmable computer system such that the respective method is carried out. Therefore, the digital storage medium may be computer readable.

Some embodiments of the invention comprise a data carrier having electronically readable control signals capable of interfacing with a programmable computer system so as to perform any of the methods described herein.

In general, embodiments of the present invention may be implemented as a computer program product comprising a program code, wherein the program code is for performing one of the methods when the computer program product is running on a computer. For example, the program code may be stored on a machine-readable medium.

Other embodiments comprise the computer program for performing any of the methods described herein stored on a machine-readable medium.

In other words, therefore, one embodiment of the present invention is a computer program comprising a program code for performing one of the methods described herein when the computer program is running on a computer.

Thus, another embodiment of the present invention is a storage medium (or a data carrier or computer readable medium) on which the computer program for performing one of the methods described herein is stored when executed by a processor. The storage medium, digital storage medium or recorded medium is typically tangible and/or non-transferable. Another embodiment of the present invention is an apparatus as described herein including a processor and the storage medium.

Thus, another embodiment of the invention is a data stream or sequence of signals constituting the computer program for performing one of the methods described herein. For example, the data stream or sequence of signals may be configured to be transmitted via a data communication link, for example via the Internet.

Another embodiment comprises a processing means, such as a computer or programmable logic device, configured or modified to perform any of the methods described herein.

Another embodiment comprises a computer on which the computer program for performing one of the methods described herein is installed.

Another embodiment of the invention comprises a device or system configured to transmit (e.g., electronically or optically) a computer program to a receiver for performing any of the methods described herein. The receiver may be, for example, a computer, a mobile device, a storage device, or the like. The device or system may include, for example, a file server for transmitting the computer program to the receiver.

In some embodiments, a programmable logic device (e.g., a field programmable gate array) may be used to perform some or all of the functions of the methods described herein. In some embodiments, a field programmable gate array may cooperate with a microprocessor to perform any of the methods described herein. In general, the methods are preferably performed by any hardware device.

### LIST OF REFERENCE SIGNS

1 Machine, plant
2 System
3 Master module
4 Module, switch, component, connection module
5 Devices, sensor technology, actuator
6 Hub
8 Control device, PLC
9 Control cabinet
10 Installation element
11 Identifier
12 Means for identification, machine-readable code
13 Power supply
20 Computer program
21 Bus system
22 Detection device
30 Apparatus
31 Computer
32 User interface
33 Data memory
41 Display element
42 Connection point, slot
100 Method
101 First method step
102 Second method step
103 Third method step
104 Fourth method step
200 Installation specification
301 User login
302 Project selection
303 Instructions start
304 Illustration of last executed step
305 Identification of an installation element, in particular a cable
306 Signal to component to light up the display element
307 Connection between cable and module established
308 Confirmation of correct assembly
309 Documentation correct assembly
310 Documentation Work step completed
311 Presentation of machine overview
312 Identification of an installation element

1. A method for operating a connection module in a computer-aided installation of a machine, in particular a plant, wherein the connection module is designed for a decentralized and modular connection of components of the machine, wherein the method comprises the following steps:
Receiving an installation function of the connection module for the installation of the machine, wherein the installation function initiates an output of an installation information for supporting an establishment of the connection of the components;
Receiving an operational function of the connection module for an operation of the installed machine, the operational function initiating an electrical output to the connected components; and
Initiating an installation mode on the connection module, wherein the operational function is deactivated and the installation function is activated.

2. The method according to claim 1, wherein the connection module has at least one display element in order to provide a display for the operational function, wherein the at least one display element is in each case assigned to a connection point of the connection module for the connection with a component to be connected in each case, wherein the method comprises the following step:
Initiating activation of the display element by the installation function to output the installation information to indicate the connection point for the component to be connected.

3. The method according to claim 2, wherein initiating the activation of the display element is based on the following steps to initiate the output of the installation information based on a received identifier and an installation specification:
Receiving the installation specification, which specifies an assignment of the connection module and further spatially decentralized connection modules of the machine with the components;
Receiving the identifier of the respective component to be connected, wherein the component is provided in the form of an installation element or other component; and
Identifying the component to be connected in each case and/or the connection module assigned to the connection based on the installation specification provided.

4. The method according to claim 1, wherein the method further comprises the following step:
Receiving a test function for testing the establishment of the connection and/or a function of the components and/or the operational function and/or a connection state of the connection, wherein the test function initiates the electrical output to the respective connected component.

5. The method according to claim 1, wherein the operational function initiates the electrical output in the form of an output of an electrical current and/or an electrical voltage to the components, wherein the electrical output is provided at connection points of the connection module for connecting the components in order to operate the components connected to the connection points.

6. The method according to claim 5, wherein the deactivation of the operational function is performed to prevent the respective component to be connected from being operated during the installation, wherein in the installation mode the electrical current and/or the electrical voltage at the respective connection point is at least reduced.

7. The method according to claim 1, wherein after a completion of the installation, the installation mode is exited and an operational mode for providing the operational function is initiated.

8. The method according to claim 7, wherein the connection module has at least one display element in order to provide a display for the operational function, wherein the at least one display element is assigned to at least one connection point of the connection module, wherein in operational mode the display element lights up in a different color and/or a different flashing frequency and/or a different brightness than in installation mode.

9. The method according to claim 7, wherein the electrical output is provided at connection points of the connection module for the connection of the components, wherein the electrical output at the connection points is defined in operational mode by a control device outside the connection module, and is defined in installation mode by an installation device outside the connection module and the control device, wherein preferably a functional connection to the control device for controlling the components via the connection points is active and/or configured in operational mode and inactive and/or unconfigured in installation mode.

10. The method according to claim 1, wherein the installation mode is signaled by at least one display element of the connection module to visibly distinguish the installation mode from the operational mode by means of the at least one display element.

11. The method according to claim 1, wherein the components comprise at least one connecting element and/or a cable and/or a component and/or an actuator and/or a sensor and/or a further connection module.

12. The method according to claim 1, wherein an initiation of an activation of a display element of the connection module by the installation function for outputting the installation information is synchronized with an output of a further installation information in the form of an installation instruction for assisting a user with the installation, the output of the further installation information comprising at least one of the following steps:
Initiating an indication of a connection point, in particular a slot, of the electrical component for the installation element on a user interface of a computer, wherein the user interface visualizes a digital twin of at least a part of the machine;
Initiating an indication of a connection point, in particular a slot, of the electrical component for the installation element by means of augmented reality and/or by means of an item of clothing and/or by means of a detection device and/or by means of an optical and/or acoustic signal;
Initiating an output of the installation instruction as an instruction for the user to connect the installation element to a specific connection point of the electrical component;
Initiating an acoustic output, in particular a voice output, of the installation instruction.

13. (canceled)

14. A non-transitory computer-readable medium storing comprising instructions which, when executed by a computer, cause the computer to:
Receive an installation function of the connection module for the installation of the machine, wherein the installation function initiates an output of an installation information for supporting an establishment of the connection of components of the machine;
Receive an operational function of the connection module for an operation of the installed machine, the operational function initiating an electrical output to the connected components; and
Initiate an installation mode on the connection module, wherein the operational function is deactivated and the installation function is activated.

15. An apparatus for data processing:
a connection module configured for decentralized and modular connection of components of a machine; and
a computer readable medium commutatively coupled to the connection module and comprising computing instructions for computer-aided installation of the machine, the computing instructions, when executed by one or mor processors, cause the one or more processors to:
Receive an installation function of the connection module for the installation of the machine, wherein the installation function initiates an output of an installation information for supporting an establishment of the connection of components of the machine;
Receive an operational function of the connection module for an operation of the installed machine, the operational function initiating an electrical output to the connected components; and
Initiate an installation mode on the connection module, wherein the operational function is deactivated and the installation function is activated.
